(19) United States
(12) Patent Application Publication
(10) Pub. No.: US 2004/0060461 A1
(43) Pub. Date: Apr. 1, 2004

(54) Slide-falling preventing apparatus of a mechanical press

(75) Inventor: Nobuo Koizumi, Komatsu-shi (JP)

Correspondence Address: ARMSTRONG, KRATZ, QUINTOS, HANSON & BROOKS, LLP, 1725 K STREET, NW, SUITE 1000, WASHINGTON, DC, 20006, US

(73) Assignee: KOMATSU ARTEC LTD., Komatsu-shi (JP)

(21) Appl. No.: 10/668,177

(22) Filed: Sep. 24, 2003

(30) Foreign Application Priority Data
Sep. 27, 2002 (JP) 2002-283563

(51) Int. Cl. F16P 1/00

(52) U.S. Cl. 100/341

(57) ABSTRACT

It is an object of the invention to provide a simple and small slide-falling preventing apparatus capable of reliably preventing a slide from falling within a short time in an arbitrary slide position without slight falling of the slide, and capable of being additionally mounted to an existing press machine with small modification within a short time while securing excellent maintainability. The slide-falling preventing apparatus comprises an external tooth gear of a rotating and driving system of a slide, an external tooth gear mounted on a rotation shaft of a rotating and driving system of a slide or an external tooth gear which meshes with a tooth gear of a rotating and driving system of a slide. The slide-falling preventing apparatus comprises a meshing member capable of meshing with at least one of teeth of the external tooth gear, the meshing member being provided such that the meshing member can engage with and disengage from the tooth of the external tooth gear from its radial direction, and meshing member inserting means for advancing and retreating the meshing member in the radial direction of the external tooth gear. The slide-falling preventing apparatus also comprises a meshing member moving means which can move the meshing member in a substantially tangent direction of the external tooth gear and can position the meshing member.

### TECHNICAL FIELD

The present invention relates to a slide-falling preventing apparatus of a mechanical press having a rotating driving system.

### BACKGROUND ART

Generally, a press is provided at an upper portion of its body with a slide such that the slide can move vertically, and a lower portion of the body is provided with a bed. An upper die and a lower die are respectively mounted on a lower end surface of the slide and an upper surface of the bed or a bolster to move the slide vertically, and a work piece is sandwiched, pressurized and formed between the upper die and the lower die. In such a press, when the dies are exchanged or maintenance is performed, an operator often needs to stop the press and enter below the lower portion of the slide which is a working region.

Therefore, a conventional slide is usually provided with an apparatus which can mechanically prevent the slide from falling, and various slide-falling preventing apparatuses have been proposed.

As such a slide-falling preventing apparatus, Japanese Utility Model Application Laid-open (KOKAI) No. 2-123399 discloses a slide locking apparatus. In this locking apparatus, a press body is provided at its upper portion with a crown, the crown being provided at its lower portion with a locking pin which projects and retreats by driving means, and the slide is provided at its upper portion with a lower locking member. The lower locking member is formed with long holes in the vertical direction at a constant pitch such that the locking pin is inserted into the long hole at a stopping position of the slide.

Japanese Patent Application Laid-open (KOKAI) No. 10-29100 discloses a press having a slide which can move in the vertical direction by slide driving means. The slide driving means is provided on an upper portion of a press body. A plurality of screw levers are located on both sides of the slide and provided on a lower portion of a crown, the screw levers can move vertically and is rotated by rotation driving means. The slide is provided at its both sides with brackets. The screw levers are respectively provided at their lower portions with locking members. Locking means locks and unlocks the slide by turning the screw levers. Stopper means stops the turning motion of the screw lever at a locking position and an unlocking position of the locking means. A locking member of a lower portion of the screw lever provided on the lower portion of the crown is received and positioned by the bracket provided on the side of the slide in a state of the locking position, thereby fixing the slide at a predetermined arbitrary position. With this structure, locking time and lock-releasing time of the slide could greatly be shortened.

Japanese Patent Application Laid-open (KOKAI) No. 8-238600 discloses an apparatus for positioning a slide. In its press having a slide which moves in the vertical direction, a rack is vertically disposed along an upright fixed wall. An upper portion of a tooth groove is inclined upward, and a lower portion of the tooth groove is directed horizontally. A rack cylinder moves the rack in the vertical direction. A direction switching valve switches working fluid flowing into the rack cylinder to allow vertical movement and free movement of a piston. A locking cylinder meshes with the rack by a rod tip end hardware fixed to the slide, and locks the rod when a pressure of the working fluid becomes lower than a predetermined value. The position of the slide is determined by inserting the rod tip end hardware provided on the slide into a tooth groove of the rack provided in the fixed wall of the press. As an effect of this apparatus, the slide was surely prevented from falling lower than a predetermined position even if a brake or the like which prevents the slide from falling was loosened and the slide fell by any possibility.

Japanese Patent Application Laid-open (KOKAI) No. 10-216998 discloses a slide-falling preventing apparatus of a transfer press. In the transfer press, an external tooth gear is fixed to a press driving shaft which vertically moves a plurality of slides through a crank gear mechanism. An internal tooth body is slidably fitted over a press driving shaft in an axial direction thereof, and the internal tooth body can engage with the external tooth gear. An engaging/disengaging cylinder slides in an axial direction of the drive shaft to bring the internal tooth body into engagement with and disengagement from the external tooth gear. A locking jack pushes and rotates a projection of the internal tooth body in a tangent direction to adjust a fitting position between the internal tooth body and the external tooth gear. The locking jack sandwiches the projection from a tangent direction, the projection being provided on the internal tooth body at the adjusted position where the internal tooth body is fitted into the external tooth gear, thereby locking the slide. According to this publication with this structure, the slide could reliably be locked at an arbitrary position, and a plurality of slides of the transfer press could be locked at one location.

In recent years, concerning the slide-falling preventing apparatus, users of the press equipment strongly desire that when dies are exchanged or maintenance is performed, in order to improve productivity by enhancing the operation rate of machinery, slides are surely locked or unlocked within a short time at an arbitrary slide position, and never fall after being locked for a security reason. Further, in order to enhance the maintainability to shorten the machine-stop time when the apparatus is out of order, it is desired that accessibility to the apparatus and maintainability from outside are excellent.

Further, as high emphasis is put on safety in recent years, various regulations are set. Existing press machines are not exceptions, and users of the press equipment increasingly desire to additionally provide a slide-falling preventing apparatus with small modification in a short term at the time of retool fit operation, for example.

Since the users of the press equipment desire that the apparatus has excellent cost performance of course, the apparatus should have a simple structure and its size should be small.

From such points of view, each of the conventional techniques is reviewed. According to the technique described in Japanese Utility Model Application Laid-open (KOKAI) No. 2-123399, there disclosed the locking apparatus of a slide in which the locking pin provided on the lower portion of the crown is inserted into the long hole of the lower locking member provided on the upper portion of the slide at the stopping position of the slide. If an attempt is made to lock the slide at an arbitrary position of the entire stroke, it is necessary to dispose a lower locking member having a length of the entire stroke of the slide between the lower portion of the crown and the upper portion of the slide. Further, a slide position detecting mechanism must be provided. It is extremely difficult to provide such a wide space in an upper portion or a side portion of the slide. Since the lower locking member must be inserted into the long hole, there is a room that the slide falls by a given amount until the locking pin is stabilized at an upper end position in the long hole after the locking pin is inserted. For these reasons, the slide can not be stopped at the arbitrary position.

Since the locking apparatus of the slide of this technique is provided between the lower portion of the crown and the upper portion of the slide, accessibility and maintainability are inferior. Further, when the locking apparatus of the slide is additionally mounted on an existing press machine, since additional operation is required on the lower portion of the crown and the upper portion of the slide, the mounting operation is extremely difficult.

Further, according to the technique disclosed in Japanese Patent Application Laid-open (KOKAI) No. 10-29100, in order to fix the slide at a predetermined arbitrary position, if the slide stops at the arbitrary position, it is necessary to move (move more than the entire stroke of the slide in some cases) a locking member on the lower portion of the screw lever from its standby position to a bracket position in the slide stopping position by means of a screw driving. Therefore, it takes long time to move the locking member and to lock the slide. Further, a space for the screw lever must be provided on the side of the crown to allow the screw lever to elevate, and a structure of a plate member of the crown frame becomes complicated.

Further, since the slide locking apparatus of this technique is provided between the lower portion of the crown and both sides of the slide, the maintainability and the accessibility at the time of maintenance are inferior.

Further, when the slide locking apparatus is additionally mounted on an existing press machine, additional operation such as welding is required on the lower portion of the crown and both sides of the slide. Since the apparatus is complicated, it is difficult to adjust a straightness of the member after the additional operation, which makes the mounting operation difficult. In order to secure the accommodation space for the screw lever to elevate with minimum additional operation of the crown, the installation space is largely limited.

According to the technique disclosed in Japanese Patent Application Laid-open (KOKAI) No. 8-238600, in order to reliably insert the rod tip end hardware provided on the side of the slide into the rack provided on the side of the fixed wall, this rack is moved by a predetermined amount in the vertical direction by the rack cylinder. After the rod tip end hardware is inserted into the rack, in this inserted state, the slide is allowed to fall together with the rod tip end hardware and the rack, the lower end of the rack is brought into abutment against the rack supporting member (stopper) on the lower portion of the press, thereby stopping the slide. Therefore, after the rod tip end hardware is inserted into the rack at an arbitrary stopping position (desired position to lock the slide), the slide falls by a slight amount. Therefore, the slide can not be locked at an arbitrary stopping position of course, and a requirement in which slide is not allowed to fall can not be satisfied.

Further, since the rack is provided on the upright fixed wall of the press body and the rod tip end hardware is provided on the side of the slide, the slide locking apparatus of this technique is provided between the upright fixed wall and both sides of the slide, and the maintainability and the accessibility at the time of maintenance are inferior like the above two conventional techniques.

When this slide locking apparatus is additionally mounted to an existing press machine, additional operation is required on the upright fixed wall and both sides of the slide, and since the apparatus is complicated, it is difficult to adjust the members after the additional operation and thus, the mounting operation is difficult.

According to the technique disclosed in Japanese Patent Application Laid-open (KOKAI) No. 10-216998, the internal tooth body is fitted over a tooth portion of the external tooth gear which is coaxially mounted to a press driving shaft which is a prime mover output shaft of the transfer press, and the rotation of this internal tooth body is restrained, thereby stopping the rotation of the press drive shaft which drives the slide, and the slide is prevented from falling. Since the internal tooth body covers an outer periphery of the external tooth gear, and the rotation of the internal tooth body is strongly restrained, high rigidity is absolutely necessary and thus, the apparatus must be increased in size. Further, since it is necessary to precisely slide the internal tooth body in the coaxial direction with the external tooth gear, these apparatuses must have high rigidity and the structures become more complicated and become bigger in size.

In order to fit the internal tooth body over the external tooth gear, fitting condition such as coaxial degree and rotation phase between the external tooth gear and the internal tooth body is strict. However, over the long using years, rattle is generated by friction of the sliding portions of the internal tooth body and the shaft is bent by deviated load, the coaxial degree between the external tooth gear and the internal tooth body is deteriorated, leading an adverse possibility that fitting operation can not be carried out appropriately, and the reliability is deteriorated.

According to this technique, the slide-falling preventing apparatus is specified into the transfer press which drives a plurality of slides using one prime mover. If this apparatus is applied to an eccentric press or a link press in which each slide has one prime mover, there is no space for installing the large slide locking apparatus, and it is extremely difficult to dispose the locking apparatus, since the drive shaft of the press machine is usually provided in the crown. If the locking apparatus is provided in the crown while sacrificing the original layout of the drive shaft and producing cost, accessibility to the apparatus and maintainability become inferior.

When this slide locking apparatus is additionally mounted to an existing press machine such as the eccentric press or the ling press, if the locking apparatus could be mounted, since it is necessary to provide the apparatus in the crown, large modification is required by sacrificing the original layout of the drive shaft and the producing cost, and enormous cost and time are required. Therefore, it is practically very difficult to additionally mount the slide locking apparatus to the existing press machine.

The present invention has been accomplished in view of the above problems, and it is an object of the invention to provide a simple and small slide-falling preventing apparatus capable of reliably preventing a slide from falling within a short time in an arbitrary slide position without slight falling of the slide, and capable of additionally mounting the apparatus to an existing press machine with small modification within a short time while securing excellent accessibility to the apparatus and maintainability.

### DISCLOSURE OF THE INVENTION

To achieve the above object, a slide-falling preventing apparatus of a mechanical press of the present invention provides a meshing member capable of meshing with at least one of teeth of an external tooth gear provided on a rotating and driving system of a slide, and meshing member inserting means for advancing and retreating the meshing member in the radial direction of the external tooth gear, wherein the meshing member is provided such that the meshing member can mesh with and disengage from the tooth of the external tooth gear from its radial direction.

According to the present invention, since the external tooth gear provided on the side of the rotating and driving shaft of the slide is stopped, the deceleration is smaller as compared with the slide body, and the rotation shaft on the prime mover's side which has smaller driving torque is locked. The load is smaller as compared with a conventional falling preventing apparatus in which a weight of the slide is directly supported, and the apparatus can be simple in structure and can be reduced in size.

In some cases, the rotating and driving apparatus of the slide of a mechanical press is placed on an upper portion of the crown in a transfer press, but is usually placed in the crown above the press, its rotation shaft being placed horizontally, and any tooth of the external tooth gear mounted on this shaft is closer to an upper surface of the crown in many cases. The driving operation of the slide is stopped by inserting the meshing member provided on a tip end of the meshing member inserting means into the external tooth gear from its radially outside direction, thereby meshing the external tooth gear and the meshing member with each other. The apparatus of the present invention is mounted on the upper surface of the crown, and the meshing member can be inserted into the tooth of the external tooth gear in the radial direction from above (outside). Therefore, the slide-falling preventing apparatus can additionally and inexpensively be mounted on most of existing mechanical press such as the transfer press, the eccentric press and the link press only by slight additional operation with small modification for an extremely short time.

Further, since the apparatus can be disposed outside above the crown, accessibility to the apparatus and maintainability are excellent.

In the present invention, disengagement of the meshing member which allows the slide to freely move in the vertical direction is carried out in a state in which the external tooth gear can rotate without interfering with the meshing member. Therefore, the moving amount required for engaging and disengaging the meshing member is only a length of about one pitch between the teeth of the gear, and this moving amount is extremely shorter than that of each of the conventional technique. Thus, the slide-falling preventing motion time can be greatly shortened.

In the present invention, the external tooth gear may be fixed to a drive shaft which drives the slide, or may mesh with a gear fixed to a drive shaft which drives the slide, or may be mounted on a shaft end of a drive shaft which drives the slide.

In the present invention, it is preferable that the slide-falling preventing apparatus comprises a meshing member moving means capable of moving the meshing member in a substantially tangent direction of the external tooth gear and positioning the meshing member.

With this arrangement, when the meshing member meshes with the external tooth gear, since the meshing member is moved by a predetermined amount in the substantially tangent direction of the external tooth gear and is positioned by the meshing member moving means, it is possible to move the meshing member to a position where the meshing member smoothly meshes with the external tooth gear. With this arrangement, even if the slide is in any stroke position, i.e., even if the external tooth gear is in any position with respect to the meshing member, it is possible to lock the rotation of the rotating driving shaft of the slide and ensure to lock the slide driving by inserting the meshing member extremely smoothly in a short time into the external tooth gear from the radially outside, while determining the best position of meshing member by slightly moving it to the position where meshing member can mesh smoothly with at least one of teeth of the external tooth gear.

The moving distance for positioning the meshing member is as short as one pitch between the teeth of the external tooth gear at the maximum, the moving distance of the apparatus of the present invention is extremely shorter than that of any of the conventional slide-falling preventing apparatuses. Thus, the operation time can remarkably be shortened.

It is preferable that a meshing portion of the meshing member is a rack. With this arrangement, since the rack can be inserted into the tooth groove between the teeth to be engaged in a wedge-like form as the meshing portion of the meshing member from the tip of tooth of the rack to the radial direction of the external tooth gear, the meshing operation is extremely smoothly and reliably carried out, shortening the insertion time and the reliability of locking operation of the slide is enhanced.

It is preferable that the meshing member inserting means includes a meshing member insertion screw and a nut which mesh with each other and either of which being fixed to or supported by the meshing member, and meshing member insertion driving means which rotates and drives either of the meshing member insertion screw or the nut, and which can advance and retreat the meshing member in the radial direction of the external tooth gear.

With this structure, since the driving mechanism of engaging the meshing member with the external tooth gear and disengaging operation of the meshing member comprises the screw and the nut, the mechanism also exhibits the rotation holding function of the screw after the meshing by the screw having the predetermined friction coefficient and the screw pitch, i.e., the holding function of the locking of the slide movement, the number of parts is reduced, and the apparatus is simplified and reduced in size.

In the present invention, it is preferable that the meshing member moving means includes a carrier for supporting the meshing member such that the meshing member can advance and retreat, a meshing member moving screw and a nut which mesh with each other and either of them being fixed to or supported by the carrier, and meshing member moving driving means which rotates and drives either of the meshing member moving screw or the nut, and can move the carrier together with the meshing member in a tangent direction of the external tooth gear and can position the carrier.

With this structure, the carrier which supports the meshing member such that the meshing member can advance and retreat is moved together with the meshing member in the tangent direction of the external tooth gear by a feed screw mechanism and the meshing member can be positioned. Therefore, even if the external tooth gear is located at any position, it is possible to move the meshing member to a position where the meshing member smoothly meshes with the external tooth gear. At that time, since the driving mechanism of the meshing member moving means comprises the screw and the nut, the mechanism also exhibits the rotation holding function of the screw after the meshing by the screw having the predetermined friction coefficient and the screw pitch, i.e., the holding function of the locking of the slide movement, the number of parts is reduced, and the apparatus is simplified and reduced in size.

### BRIEF DESCRIPTION OF THE DRAWINGS

FIG. 1 is a schematic view of a slide-falling preventing apparatus according to a first embodiment of the present invention;

FIG. 2 is a side view of installation of the slide-falling preventing apparatus of the first embodiment to a press;

FIG. 3 is a plan view of installation of the slide-falling preventing apparatus of the first embodiment to the press;

FIG. 4 shows meshing member moving means of the first embodiment;

FIG. 5 shows meshing member inserting means of the first embodiment;

FIG. 6 is a schematic view of a slide-falling preventing apparatus of a second embodiment;

FIG. 7 is a side view of installation of the slide-falling preventing apparatus of a third embodiment to a press;

FIG. 8 is a side sectional view of the slide-falling preventing apparatus of the third embodiment to a press; and

FIG. 9 shows installation of a slide-falling preventing apparatus of a fourth embodiment to a press.

### BEST MODE FOR CARRYING OUT THE INVENTION

Next, concrete embodiments of the slide-falling preventing apparatus of a mechanical press of the present invention will be explained with reference to the drawings.

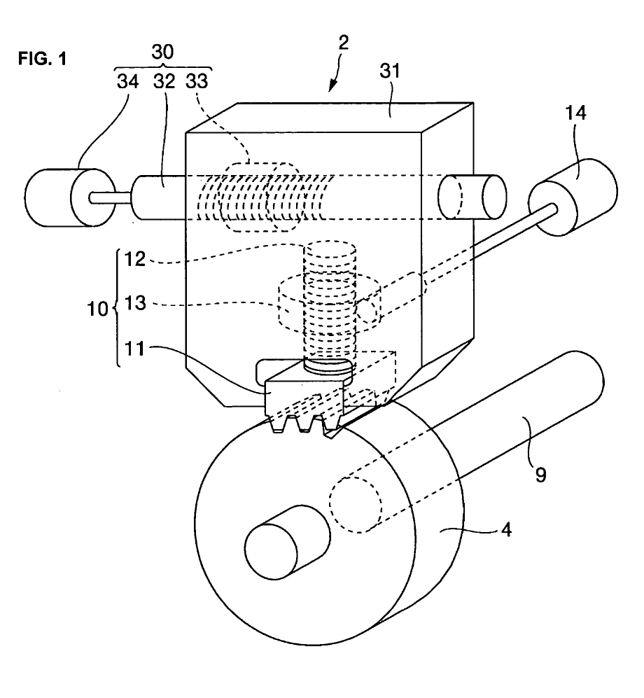

A first embodiment will be explained using FIGS. 1 to 5.

FIG. 1 is a schematic view of a slide-falling preventing apparatus according to the first embodiment of the invention.

A slide-falling preventing apparatus 2 of this embodiment comprises a meshing member 11 which meshes with a tooth of an external tooth gear 4 fixed to a slide drive shaft 9 of a mechanical press (not shown) from its radially outside in such a manner that the meshing member 11 can advance and retreat, thereby restraining the rotation of the external tooth gear 4, meshing member inserting means 10 which advances or retreats the meshing member 11 to insert or separates the meshing member 11 into or from the tooth of the external tooth gear 4 from radially outside, and meshing member moving means 30 which moves a carrier 31 having the meshing member inserting means 10 in a tangent direction of an outer periphery of the external tooth gear 4 so as to easily bring the meshing member 11 into a meshed state with the tooth of the external tooth gear 4 which is in an arbitrary rotation position.

The meshing member inserting means 10 includes a meshing member insertion screw 12 provided at its tip end with the meshing member 11, a meshing member insertion nut 13 which is threadedly engaged with the meshing member insertion screw 12, and meshing member insertion driving means 14 which rotates and drives the nut 13. The meshing member moving means 30 includes a meshing member moving screw 32 which is rotatably supported by a press body or a bracket which is fixed to the press body and which is fixed in the axial direction, a meshing member moving nut 33 which is fixed to the carrier 31 and threadedly engaged with the meshing member moving screw 32, and meshing member moving driving means 34 which rotates and drives the meshing member moving screw 32 and moves the meshing member 11 through the carrier 31.

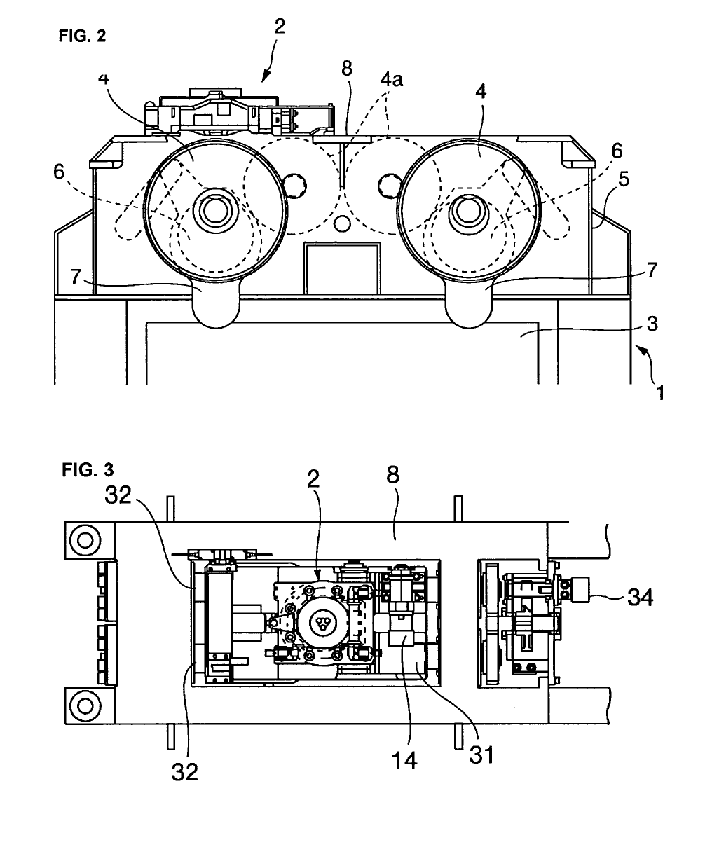

FIG. 2 is a side view of installation of the slide-falling preventing apparatus of the first embodiment of the invention to the press. An embodiment of installation of the apparatus to the mechanical press will be explained using FIG. 2. The mechanical press machines or processes a work piece by vertical movement of the slide 3 between a lower die (not shown) placed on a bed or a on the upper surface of bolster and an upper die (not shown) mounted on a lower surface of the slide 3.

A crown 5 is disposed on an upper portion of a machine body 1 of the mechanical press. The crown 5 is provided therein with a rotation driving mechanism for vertically moving the slide 3. The rotation driving mechanism includes a pair of external tooth gears 4 and 4 which receive rotation power of a rotating driving motor through a plurality of gears 4a and transmit the rotation power to a pair of eccentric shafts 6 and 6, and links 7 whose one ends are rotatably connected to eccentric positions of the eccentric shafts 6 which convert the rotation motion of the pair of eccentric shafts 6 and 6 into vertical motion. The slide 3 is disposed below the crown 5, the slide 3 being connected to the other end of each of the link 7, and with this structure, the slide 3 is vertically moved.

The slide-falling preventing apparatus 2 of this invention is disposed on an upper surface of the crown 5 such that the slide-falling preventing apparatus 2 is engaged with tooth located at an upper portion of the external tooth gear 4.

FIG. 3 is a plan view of installation of the slide-falling preventing apparatus of the first embodiment of the invention to the press machine, in which the slide-falling preventing apparatus 2 is viewed from above. In FIG. 3, the crown 5 is provided at its upper surface with a frame 8 which is strongly fixed to the crown 5. The carrier 31 of the slide-falling preventing apparatus 2 is disposed in an opening which is formed in substantially a central portion of the frame 8. The carrier 31 is axially movably supported by the frame 8 by means of two meshing member moving screws 32 and 32. The carrier 31 can move only in a lateral direction on the frame 8 as illustrated.

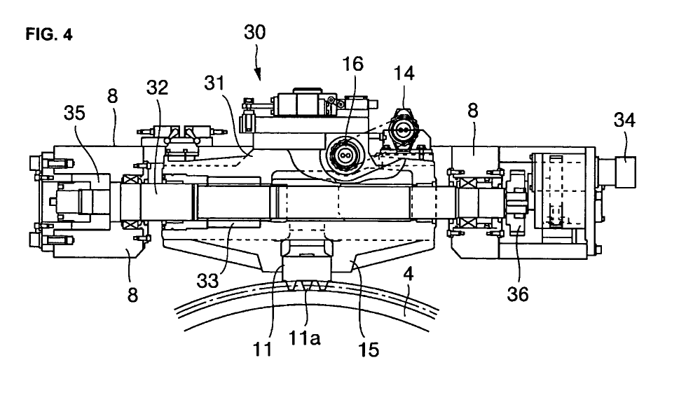

FIG. 4 shows the meshing member moving means 30 of the first embodiment, and is a vertical sectional view of the meshing member moving screw 32. As shown in FIG. 4, the meshing member moving means 30 includes meshing member moving driving means 34 comprising an electric motor etc., moving driving and transmitting means 36 for transmitting rotation power of the meshing member moving driving means 34, a meshing member moving screw 32 which is rotatably supported by a meshing member thrust receiver 35 and is rotated and driven through the moving driving and transmitting means 36 such that an axial movement of the meshing member moving screw 32 is restrained by the frame 8, a nut 33 threadedly engaged with the meshing member moving screw 32, and the carrier 31 fitted and fixed over the outer periphery of the nut 33. The carrier 31 can move in a substantially tangent direction (lateral direction in FIG. 4) of the outer periphery of the external tooth gear 4 by relative rotation between the meshing member moving screw 32 and the nut 33.

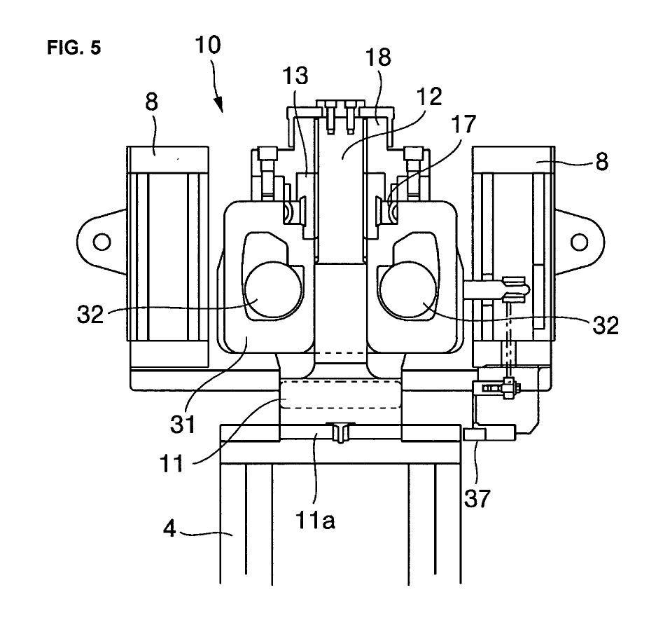

FIG. 5 shows the meshing member inserting means 10 of the first embodiment, and is a vertical sectional view of the meshing member insertion screw 12. In FIG. 5, the meshing member inserting means 10 includes the meshing member insertion driving means 14 (shown in FIG. 4) comprising an electric motor etc., first insertion driving and transmitting means 16 which transmit the rotation power of this meshing member insertion driving means 14 to the nut 13, (which is driven by a chain in this embodiment, see FIG. 4) and a second insertion driving and transmitting means 17 (which is driven by a worm gear in this embodiment) and the nut 13 which is allowed to rotate and drive through the insertion driving and transmitting means 16 and 17 and which is restrained from moving in the axial direction by carrier 31 through the nut holder 18, the meshing member insertion screw 12 which is threadedly engaged with an inner diameter screw of the nut 13 and which can move in the axial direction (vertical direction in FIG. 5) guided by the carrier 31, and the meshing member 11 which is integrally fixed to a tip end of the meshing member insertion screw 12, which is allowed to move only in the axial direction by a detent member 15 (shown in FIG. 4) and which is restrained from rotating.

A rack 11a is employed as a meshing portion of a tip end (lower end in the drawing) of the meshing member 11. The shape of the meshing portion is not limited to the rack 11a, and may be wedge-like shape or trapezoidal shape.

A carrier position detector 37 is provided in the vicinity of the side of tooth of the external tooth gear 4 which is disposed below the frame 8. The meshing portion on the tip end of the meshing member 11 is inserted into the external tooth gear 4. The carrier position detector 37 detects a relative position of the meshing member 11 with respect to the tooth of the external tooth gear 4. The relative position should be a position where the meshing member 11 is inserted most suitably.

The carrier position detector 37 of this embodiment is a proximity switch. The carrier position detector 37 detects a position near an upper end surface of the tooth of the external tooth gear 4 in a non-contact manner, thereby obtaining a position of the carrier 31, i.e., a position of the meshing member 11 which is suitable for inserting the meshing member 11.

Next, operation and effect of the slide-falling preventing apparatus 2 of the invention will be explained with reference to FIGS. 1 to 5. In a normal operation of the press, the meshing member 11 is lifted and the meshing member 11 is disengaged from the external tooth gear 4, and the slide 3 can be driven freely. That is, the external tooth gear 4 can freely rotate and the slide can move vertically.

When the slide-falling preventing apparatus 2 is to be operated, the slide 3 is stopped and then, the meshing member moving driving means 34 is operated to rotate and drive the meshing member moving screw 32, and the carrier 31 is allowed to move in a substantially tangent direction (leftward or rightward in FIG. 4) of the outer periphery of the external tooth gear 4 through the meshing member moving nut 33. A position of the tooth of the external tooth gear 4 where the meshing member 11 can mesh most suitably is detected by a signal of the carrier position detector 37, the carrier 31 is stopped at that position, and the positioning is carried out. After the carrier 31 is stopped at the predetermined most suitable position and is positioned there, the meshing member insertion driving means 14 is rotated and driven, thereby advancing the meshing member insertion screw 12 in the axial direction through the nut 13, the meshing member 11 on the tip end of the meshing member insertion screw 12 is inserted into a predetermined tooth groove from radially outside, and the meshing member 11 is allowed to mesh with the tooth groove. By allowing the meshing member to mesh with a predetermined tooth of the external tooth gear 4 at an arbitrary stroke position of the slide, it is possible to lock the movement of the slide and to prevent the slide from falling.

At that time, a vertical moving distance of the meshing member 11 and a lateral moving distance of the carrier 31 may be slight distances as short as about one pitch of the tooth of the external tooth gear 4, and the operation time is remarkably shortened as opposed to conventional techniques.

As described above, it is desired to prevent a slide from falling of course, and not to fall even slightly after the slide is stopped. Therefore, after the meshing member 11 and the external tooth gear 4 mesh with each other, the meshing member 11 should not fall off or move slightly in the tangent direction of the external tooth gear 4. In this first embodiment, even if a load caused by a weight of the slide is applied to the meshing member 11 through the external tooth gear 4, since the driving mechanisms of the meshing member inserting means 10 and the meshing member moving means 30 comprise the screw and the nut having predetermined friction coefficient and screw pitch which do not allow reversible movements, a reverse rotation preventing effect is remarkable, and a fixing and maintaining function of the slide 3 is exhibited. By using the worm gear mechanism, the reverse rotation-preventing effect is further enhanced.

According to the above-described slide-falling preventing apparatus 2 of the present invention, firstly, in the rotating and driving system, since a rotation shaft having small driving torque in which the prime mover side is not decelerated as compared with the slide body being locked, the locking load is smaller as compared with a conventional falling preventing apparatus in which a weight of the slide is directly supported. Secondly, moving amount when the meshing member 11 is inserted and when the position is detected is small. Thirdly, these movements are caused by driving the screw and the nut, and the screw and the nut also have function to hold the rotation (hold the falling motion of the slide) and thus, a structure of the apparatus is simple and the apparatus can be small.

The rotation and driving apparatus of the slide of the mechanical press is usually provided in the crown on the upper portion of the press body. A rotation shaft of the rotating and driving apparatus is placed horizontally, and any tooth of the external tooth gear mounted to this shaft is close to an upper surface of the crown in many cases. On the other hand, the slide is locked by inserting the meshing member 11 provided on the tip end of the meshing member inserting means 10 into the external tooth gear 4 from radially outside by means of the meshing member inserting means 10, and by meshing the external tooth gear 4 with the meshing member 11. Therefore, the slide-falling preventing apparatus of the present invention can be mounted on the upper surface of the crown, and the meshing member 11 can be inserted, by the meshing member inserting means 10 from radially upper side, into the tooth of the external tooth gear 4 which is close to the upper surface of the crown.

Therefore, with this structure, there is an effect that the slide-falling preventing apparatus 2 can additionally and inexpensively be mounted on most of existing mechanical press such as the transfer press, the eccentric press and the link press only by slight additional operation with small modification for an extremely short time.

Further, this apparatus can be disposed outside above the crown whose upper side is completely opened. The accessibility for an operator who takes charge of maintenance to the apparatus is excellent. The accessibility to the apparatus and maintainability are excellent.

Although the driving mechanisms of the meshing member inserting means 10 and the meshing member moving means 30 comprise the screw and the nut in the above-explained first embodiment, it should not be limited to the screw and the nut that comprise the driving mechanism.

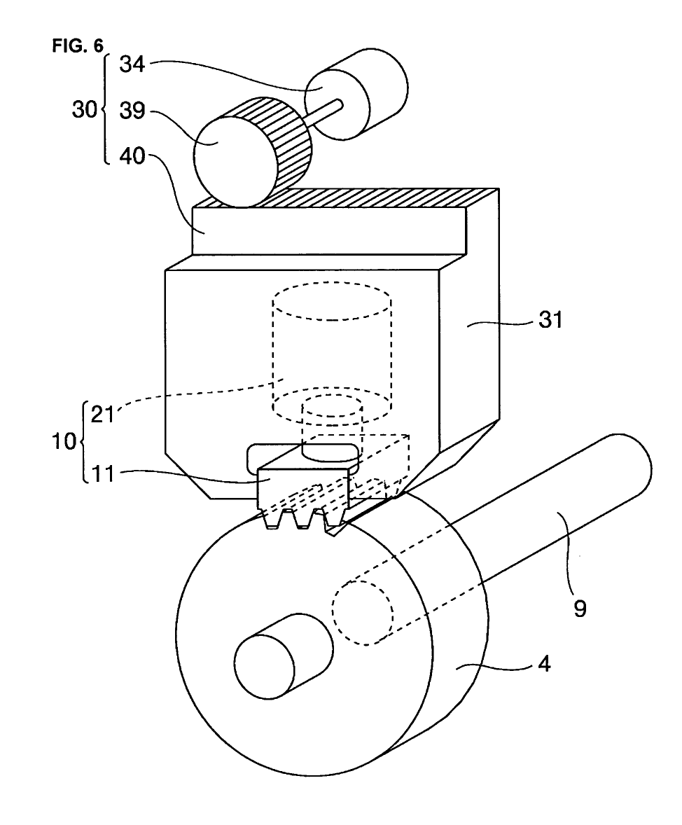

For example, FIG. 6 is a schematic view of a slide-falling preventing apparatus according to a second embodiment. As in this second embodiment, the meshing member inserting means 10 may include a meshing member insertion liquid pressure cylinder 21 (hydraulic cylinder, water pressure cylinder or the like) incorporated in the carrier 31, and the meshing member 11 fixed to a tip end of a rod of this cylinder. The meshing member moving means 30 may include a pinion 39, a moving rack 40 which meshes with the pinion 39 and moves the carrier 31 to a position of the tooth of the external tooth gear 4 where the meshing member 11 can mesh with the external tooth gear 4 most suitably, and the meshing member moving driving means 34 which rotates and drives the pinion 39.

In short, the meshing member inserting means 10 and the meshing member moving means 30 are not limited to the screw or the nut, and may use any driving structures only if they can position and stop the slide at a predetermined position.

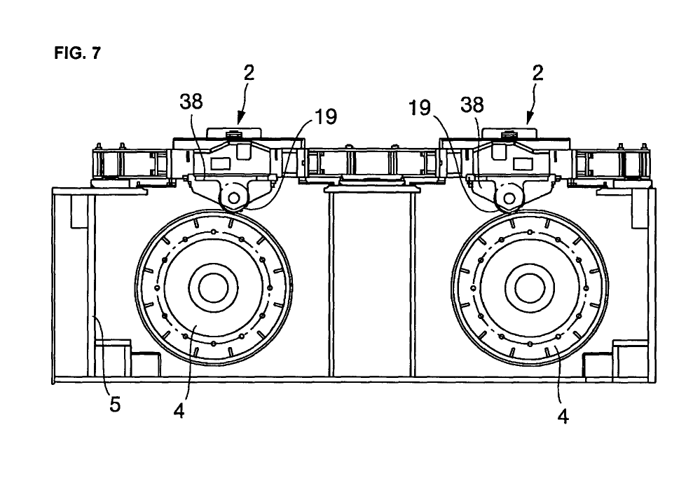

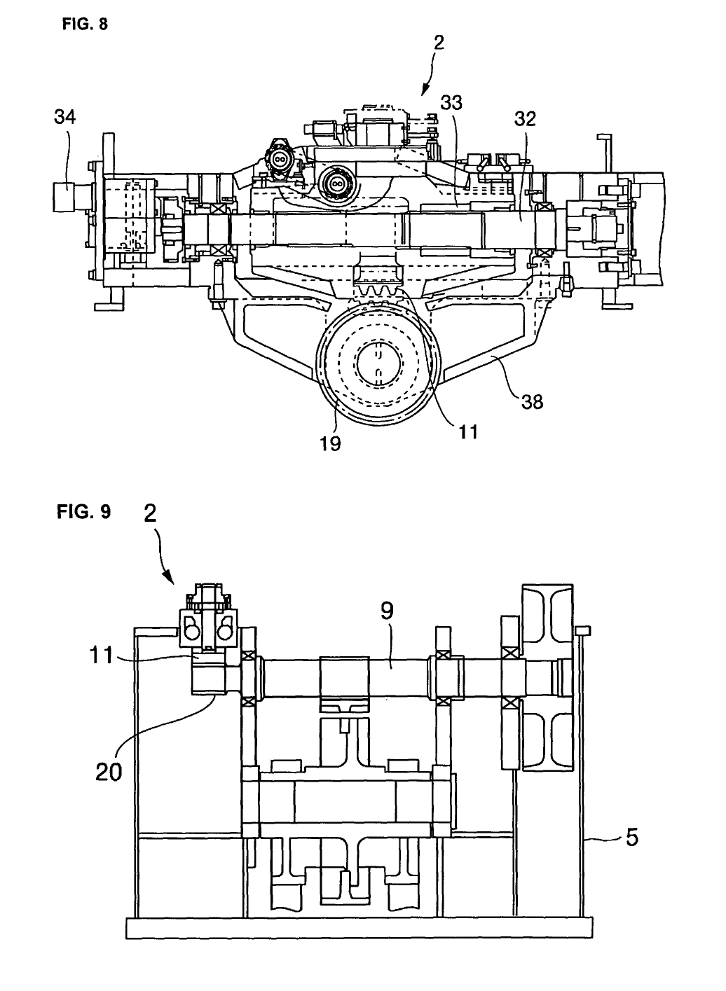

As the external tooth gear 4 which meshes with the meshing member 11 to stop the slide 3, the external tooth gear 4 which directly drives the rotating and driving system of the slide 3 may be used, but the external tooth gear 4 may indirectly mesh with the meshing member 11 through a first auxiliary tooth gear 19 as shown in FIG. 7 which is a side view of installation of the slide-falling preventing apparatus to the press according to the third embodiment and as shown in FIG. 8 which is a side sectional view of the slide-falling preventing apparatus according to the third embodiment.

In the third embodiment, as shown in FIGS. 7 and 8, in a case where the slide-falling preventing apparatus 2 is disposed on an upper surface of the crown 5 but the meshing member 11 can not directly engage with the slide driving external tooth gear 4 in the crown 5 in terms of layout because a distance between the upper surface of the crown 5 and the external tooth gear 4 is too long, the slide-falling preventing apparatus 2 is provided at its lower portion with the first auxiliary tooth gear 19 and an auxiliary tooth gear holder 38, the first auxiliary tooth gear 19 being used as an idle tooth gear, and the meshing member 11 and the external tooth gear 4 are indirectly meshed with each other.

As shown in FIG. 7, in the slide-preventing apparatus 2 of the invention, a plurality of apparatuses can be disposed on one slide 3 to reduce the apparatus in size, or to enhance the slide-holding ability.

Next, FIG. 9 shows installation of the slide-falling preventing apparatus to the press according to a fourth embodiment. In any of the above-described slide-falling preventing apparatuses 2, the meshing member 11 is directly meshed with the slide driving external tooth gear 4 or indirectly meshed with the slide driving external tooth gear 4 through the first auxiliary tooth gear 19 to lock the external tooth gear 4. In the fourth embodiment, a second auxiliary tooth gear 20 is mounted to an end of a shaft of the slide drive shaft 9 in the crown 5, the meshing member 11 is meshed with tooth of the second auxiliary tooth gear 20 to restrain the rotation of the slide drive shaft 9, thereby preventing the slide 3 from falling.

Although the second auxiliary tooth gear 20 is mounted to the shaft end of the slide drive shaft 9 in the example shown in FIG. 9, it is of course possible to mount the second auxiliary tooth gear 20 to any portion of the slide drive shaft 9.

If the structure of the fourth embodiment is applied, when the slide-falling preventing apparatus 2 is disposed on the upper surface of the crown 5, since the disposition position is not limited by the position of the external tooth gear 4, flexibility of layout of the slide-falling preventing apparatus 2 on the upper surface of the crown 5 is increased. Therefore, this technique is effective when the apparatus is additionally mounted on an existing press machine and when it is difficult to secure a mounting position because enough space can not be secured on the upper surface of the crown 5.

In the above-described embodiments, the meshing member inserting means 10 rotates and drives the nut, moves the meshing member 11 through the screw which threadedly engages with the nut, the meshing member moving means 30 rotates and drives the screw, and the carrier 31 is moved through the nut. The present invention is not limited to this structure; either of the screw or the nut may be rotated and driven, and the other may be moved. Alternatively, either the screw or the nut may be rotated, driven and moved, and the other may be fixed.

According to the present invention, the following effects can be obtained.

In the slide-falling preventing apparatus of the present invention, the meshing member is inserted into the tooth of the external tooth gear of the slide rotating and driving system from radially outside direction, thereby locking the rotating and driving shaft of the slide and stopping the movement of the slide. Further, since deceleration of the prime mover's side is smaller than that of the slide body, and since the smaller rotation shaft of the driving torque is locked, a load of the apparatus is smaller than a conventional slide-falling preventing apparatus in which the weight of the slide is directly supported. Therefore, the apparatus can be simple in structure and small in size.

In the present invention, the slide is locked by inserting the meshing member mounted on the tip end of the meshing member inserting means into the external tooth gear from above and by meshing the meshing member with the external tooth gear. Therefore, the apparatus of the invention can be mounted on the upper surface of the crown, and the meshing member can be inserted, from above (outside) in the radial direction, into the tooth of the external tooth gear located closer to the upper surface of the crown. Therefore, with this structure, there is an effect that the apparatus can additionally and inexpensively be mounted on most of existing mechanical press such as the transfer press, the eccentric press and the link press only by slight additional operation with small modification for an extremely short time.

Further, since the apparatus can be disposed outside above the crown, the accessibility to the apparatus and maintainability are excellent.

In the present invention, a moving amount required for engaging and disengaging the meshing member is only a length of about one pitch of the tooth gear, and this moving amount is remarkably shorter than that of the aforementioned conventional techniques. Thus, there is an effect that the slide-falling preventing time can largely be shortened.

In the present invention, when the meshing member is meshed with the external tooth gear, there provided the meshing member moving means for moving the meshing member by a predetermined distance in the substantially tangent direction on the outer periphery of the external tooth gear to a position where the meshing member smoothly meshes with the external tooth gear, and for positioning the meshing member. With this structure, even if the slide is in any stroke position, it is possible to move the meshing member by a slight distance in the substantially tangent direction of the outer periphery of the external tooth gear to the position where the meshing member smoothly meshes with the external tooth gear, and to position the meshing member, and to extremely smoothly insert the meshing member into the external tooth gear from the radially outside. Further, since they can reliably mesh with each other, it is possible to reliably lock the slide.

The moving distance for positioning the meshing member is as short as one pitch of the external tooth gear at the maximum, the moving distance of the apparatus of the present invention is extremely shorter than that of any of the conventional slide-falling preventing apparatuses. Thus, the operation time can remarkably be shorted.

In the present invention, if the rack is used as a meshing member which meshes with at least one of teeth of the external tooth gear, when the rack tooth is inserted into the external tooth gear in the radial direction, the meshing operation is extremely smoothly and reliably carried out, and the reliability of locking operation of the slide is enhanced, since the rack is inserted into the tooth groove in a wedge-like form.

When the screw and the nut having a predetermined friction coefficient and screw pitch are respectively used as the driving mechanism for allowing the meshing member to mesh with the external tooth gear, and the driving mechanism for moving the meshing member to position the same, they also exhibit the rotation holding function of the screw after the meshing, which is holding function of the locking state of the slide. Therefore the number of parts can be reduced, which makes it possible to simplify the apparatus of the invention and to reduce the apparatus in size.

What is claimed is:

1. A slide-falling preventing apparatus of a mechanical press comprising a meshing member capable of meshing with at least one of teeth of an external tooth gear provided on a rotating and driving system of a slide, the meshing member being provided such that the meshing member can engage with and disengage from the tooth of the external tooth gear from its radial direction, and meshing member inserting means for advancing and retreating the meshing member in the radial direction of the external tooth gear.

2. The slide-falling preventing apparatus of a mechanical press according to claim 1, wherein the external tooth gear is fixed to a drive shaft which drives the slide.

3. The slide-falling preventing apparatus of a mechanical press according to claim 1, wherein the external tooth gear meshes with a gear fixed to a drive shaft which drives the slide.

4. The slide-falling preventing apparatus of a mechanical press according to claim 1, wherein the external tooth gear is mounted on a shaft end of a drive shaft which drives the slide.

5. The slide-falling preventing apparatus of a mechanical press according to claim 1, further comprising a meshing member moving means capable of moving the meshing member in a substantially tangent direction of the external tooth gear and positioning the meshing member.

6. The slide-falling preventing apparatus of a mechanical press according to any one of claims 1 to 5, wherein a meshing portion of the meshing member is a rack.

7. The slide-falling preventing apparatus of a mechanical press according to any one of claims 1 to 5, wherein the meshing member inserting means includes a meshing member insertion screw and a nut which mesh with each other and either of which being fixed to or supported by the meshing member, and meshing member insertion driving means which rotates and drives either of the meshing member insertion screw or the nut and which can advance and retreat the meshing member in the radial direction of the external tooth gear.

8. The slide-falling preventing apparatus of a mechanical press according to claim 5, wherein the meshing member moving means includes a carrier for supporting the meshing member such that the meshing member can advance and retreat, a meshing member moving screw and a nut which mesh with each other and either of them being fixed to or supported by the carrier, and meshing member moving driving means which rotates and drives either of the meshing member moving screw or the nut, and which can move the carrier together with the meshing member in a tangent direction of the external tooth gear and can position the carrier.
